(19) United States
(12) Patent Application Publication
(10) Pub. No.: US 2011/0003175 A1
(43) Pub. Date: Jan. 6, 2011

(54) COMPOSITE PERPENDICULAR MEDIA WITH GRADED ANISOTROPY LAYERS AND EXCHANGE BREAK LAYERS

(75) Inventors: Bogdan Florin Valcu, Fremont, CA (US); Qixu Chen, Milpitas, CA (US); Connie Chunling Liu, San Jose, CA (US); Chun Wang, Fremont, CA (US); Kueir-Weei Chour, San Jose, CA (US); Shoutao Wang, Fremont, CA (US)

Correspondence Address: Hollingsworth & Funk, 8500 Normandale Lake Blvd, Suite 320, Minneapolis, MN, 55437, US

(73) Assignee: Seagate Technology LLC, Scotts Valley, CA (US)

(21) Appl. No.: 12/684,070

(22) Filed: Jan. 7, 2010

Related U.S. Application Data
(60) Provisional application No. 61/222,726, filed on Jul. 2, 2009.

(51) Int. Cl. G11B 5/33; G11B 5/84

(52) U.S. Cl. 428/800; 427/127

(57) ABSTRACT

A perpendicular magnetic recording layer may include a hard granular layer, an exchange break layer formed on the hard granular layer, and a soft granular layer formed on the exchange break layer. In some embodiments, the exchange break layer may consist essentially of ruthenium. In some embodiments, the perpendicular magnetic recording layer may include n magnetic layers and n−1 exchange break layers, where n is greater than or equal to three, and where the n−1 exchange break layers alternate with the n magnetic layers in the magnetic recording layer.

This application claims the benefit of U.S. Provisional Application No. 61/222,726, entitled “COMPOSITE PERPENDICULAR MEDIA WITH GRANDED ANISOTROPY LAYERS AND EXCHANGE BREAK LAYERS,” and filed Jul. 2, 2009, the entire content of which is incorporated herein by reference.

### SUMMARY

In one aspect, the disclosure is directed to an apparatus comprising a hard granular layer, an exchange break layer formed on the hard granular layer, and a soft granular layer formed on the exchange break layer. According to this aspect of the disclosure, the exchange break layer consists essentially of ruthenium.

The details of one or more embodiments of the invention are set forth in the accompanying drawings and the description below. These and various other features and advantages will be apparent from a reading of the following detailed description.

### BRIEF DESCRIPTION OF DRAWINGS

FIG. 1 is a schematic diagram of an example of a hard disc drive.

FIG. 2 is a schematic block diagram illustrating an example of a magnetic recording medium including a recording layer comprising a hard granular layer, an exchange break layer, a soft granular layer, and a continuous granular composite layer.

FIG. 3 is a schematic block diagram illustrating an example of a magnetic recording medium including a recording layer comprising a hard granular layer, a first exchange break layer, a soft granular layer, a second exchange break layer, and a continuous granular composite layer.

FIG. 4 is a diagram of remnant coercivity versus exchange break layer thickness for three exchange break layer compositions.

FIG. 5 is a diagram of normalized remnant coercivity versus exchange break layer thickness for three exchange break layer compositions.

FIG. 6 is a diagram of remnant coercivity versus applied magnetic field angle for three magnetic recording layer stacks.

FIG. 7 is a diagram of normalized remnant coercivity versus applied magnetic field angle for three magnetic recording layer stacks.

FIG. 8 is a scatter diagram of a measure of thermal stability versus exchange break layer thickness for a recording layer including a ruthenium exchange break layer.

FIG. 9 is a scatter diagram of switching field distribution as a function of breaklayer thickness for a series of examples of magnetic recording layers including an exchange break layer.

FIG. 10 is a diagram illustrating a comparison of remnant coercivity versus exchange break layer thickness for two recording layer stacks, one of which includes a soft granular layer and one of which does not includes a soft granular layer.

FIG. 11 is a diagram illustrating a comparison of normalized remnant coercivity versus exchange break layer thickness for two recording layer stacks, one of which includes a soft granular layer and one of which does not includes a soft granular layer.

FIG. 12 is a diagram illustrating estimated achievable areal density for a series of recording layers including exchange break layers of various thicknesses.

FIG. 13 is a schematic block diagram illustrating an example of a magnetic recording medium including a recording layer comprising a hard granular layer, a first exchange break layer, an intermediate granular layer, a second exchange break layer, a soft granular layer, a third exchange break layer, and a continuous granular composite layer.

FIG. 14 is a schematic block diagram illustrating an example of a magnetic recording medium including a recording layer comprising n magnetic layers alternating with n−1 exchange break layers.

FIG. 15 is diagram of normalized remnant coercivity versus applied magnetic field angle for a recording medium including a 5-layer recording layer and a recording medium including a 7-layer recording layer.

### DETAILED DESCRIPTION

A perpendicular magnetic recording system consists primarily of a magnetic recording and read head flying above a rotating magnetic data storage medium, on which a magnetic recording layer is deposited. The magnetic recording layer may include a plurality of grains having a random granular structure. By energizing the recording component of the recording and read head, a magnetic field is produced that induces the magnetization of grains to point either up or down, depending on the magnetization direction of the applied field. During the read process, the read portion of the recording and read head senses the magnetic flux generated by the oriented magnetic grains and interprets the magnetic flux as data.

Progress in magnetic data storage comes primarily through increasing the storage capacity of the medium, which may be accomplished by increasing the areal density of the magnetic recording layer (commonly expressed as Gigabit per square inch (Gb/in²). Magnetic data storage media with a smaller average grain diameter may allow storing the same amount of data in a smaller area. However, magnetic stability of the storage media becomes a greater concern as the storage density increases. The grains maintain their magnetization orientation due to magnetic anisotropy energy of the grains, which is proportional to the grain volume. The anisotropy energy competes with thermal energy fluctuations, which would orient the magnetization of the grains randomly, such that data storage is hindered. Thermal fluctuation energy depends only on temperature. The ratio of magnetic anisotropy energy to thermal fluctuation energy is called the energy barrier, and is a measure of the magnetic stability of the grain magnetization. The energy barrier is proportional to the volume of the grain. Reducing an average grain diameter (and thus volume) increases areal density but reduces magnetic stability.

To mitigate the reduction in magnetic stability, the average magnetic anisotropy energy of the grains can be increased. However, increasing the average magnetic anisotropy energy of the grains also increases a magnetic field required to change the magnetic orientation of the grains during the data recording process. Currently, the magnetic field the recording head is able to produce is limited by the saturation moment of the magnetic material at a tip of the recording head, and is also decreased substantially from a maximum value due to separation between the recording head and the magnetic recording layer.

Some perpendicular media have at the bottom of the magnetic recording layer a granular CoCrPt alloy layer, with lateral magnetic decoupling among the magnetic grains provided by a non-magnetic oxide (SiO₂ or TiO₂). This granular CoCrPt-alloy layer has high magnetic anisotropy, which provides magnetic stability. An M-H (magnetization-coercivity) loop of a magnetic storage medium consisting of only this layer will have a considerable slope due to demagnetizing interactions (fields) among adjacent grains. In a collection of grains under influence of demagnetizing interactions only, the magnetization orientation of the grains points randomly up and down. During a magnetic data recording process, the grains experience both an external field applied by the recording head and this demagnetizing field; thus, the applied field necessary to change magnetic orientation of the grains of the magnetic recording layer has a wide distribution, leading to recording poor performance.

In some magnetic storage media, the demagnetizing field effects are compensated for by a continuous magnetic layer, referred to as a continuous granular composite (CGC) layer, overlying the granular CoCrPt alloy layer, which provides lateral exchange interaction among the grains of the granular CoCrPt alloy layer. A magnetic storage medium including such a recording layer structure may be referred to as a continuous granular composite (CGC) medium. The lateral magnetic exchange interaction facilitates alignment of neighboring grains in the same magnetization orientation. Uniformity of lateral magnetic exchange interaction among the grains is important for good recording performance. The CGC layer typically has relatively less anisotropy energy than the granular CoCrPt alloy layer.

Besides controlling the exchange between the grains of the granular CoCrPt alloy layer, the addition of the CGC layer also decreases the average coercivity of the magnetic recording layer. In this magnetic recording layer, adding greater or lesser amounts of lateral exchange coupling controls the switching field of the medium. Usually, a thicker continuous magnetic layer leads simultaneously to more lateral exchange interaction and to a lower switching field. Increasing the lateral magnetic exchange beyond the value required to balance the demagnetizing field interactions may increase an effective magnetic grain size, due to clustering of adjacent grains due to lateral magnetic exchange. Thus, improvement of media write-ability through lateral magnetic exchange coupling is limited.

Even though a magnetic recording layer of a CGC medium is a stack composed of at least two layers, the switching of the magnetization orientation of the recording layer is coherent. In other words, all of the layers in the magnetic recording layer of a CGC medium switch substantially simultaneously. When a write field is applied at various angles with respect to the perpendicular direction, the switching field value has a minimum at about 45 degrees, and a maximum at about 0 and about 90 degrees. This is called the Stoner-Wohlfarth curve and all CGC media follow it, which indicates the coherent magnetization orientation switching of the CGC magnetic recording layer.

In the current disclosure, the magnetic recording layer structure itself allows for self-assist in the writing process. In other words, the magnetic recording layers proposed herein may have a high energy barrier, while facilitating a switching field that is used to switch the magnetization of the grains that is equal to or even less than the switching field of some media, such as CGC media.

The current disclosure describes a magnetic recording layer including at least two granular magnetic layers. The magnetic recording layer may include a soft granular layer formed over a hard granular layer. The soft granular layer has a magnetic anisotropy value that is less than the magnetic anisotropy value of the hard granular layer. The hard and soft granular layers are vertically exchange coupled, so that each magnetic grain has a magnetically soft (lower magnetic anisotropy) top and a magnetically hard (higher magnetic anisotropy) bottom. When an external magnetic field is applied to a grain, magnetic orientation of the soft portion and the hard portion switch non-coherently. In non-coherent switching, the magnetic orientation of the soft portion of the grain begins rotating before magnetic orientation of the hard portion of the grain, since the soft portion has lower magnetic anisotropy that the hard portion. Due to the vertical exchange coupling, the magnetic moment of the soft portion will exercise a magnetic torque on the magnetic moment of the hard portion, assisting with switching of the magnetic orientation of the hard portion. Deviations from the Stoner-Wolfarth curve of the remnant coercivity versus applied field angle can identify this non-coherent switching mechanism.

The magnetic anisotropy energy of the composite grain may be stored largely in the hard layer. By adding the soft layer, the average magnetic anisotropy field of the composite structure will decrease by virtue of averaging. An exchange coupled composite (ECC) effect consists of obtaining a switching field (coercivity) for the grains that is smaller than the value expected from the average of the magnetic anisotropies of the hard granular layer and the soft granular layer.

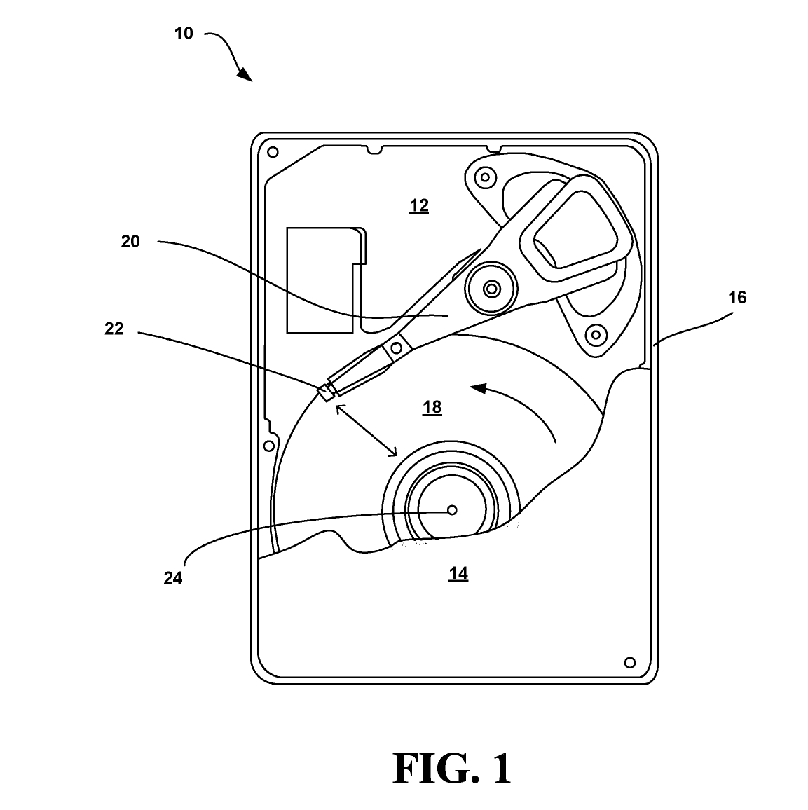

FIG. 1 illustrates an exemplary magnetic disc drive 10 including a magnetic recording and read head according to one aspect of the present disclosure. Disc drive 10 includes base 12 and top cover 14, shown partially cut away. Base 12 combines with top cover 14 to form the housing 16 of disc drive 10. Disc drive 10 also includes one or more rotatable magnetic data storage media 18. Magnetic data storage media 18 are attached to spindle 24, which operates to rotate media 18 about a central axis. Magnetic recording and read head 22 is adjacent to magnetic data storage media 18. Actuator arm 20 carries magnetic recording and read head 22 for communication with each of magnetic data storage media 18.

Magnetic data storage media 18 store information as magnetically oriented bits on a magnetic recording layer. Magnetic recording and read head 22 includes a recording (write) head that generates a magnetic field sufficient to magnetize discrete domains of the magnetic recording layer on magnetic data storage media 18. These discrete domains of the magnetic recording layer each represent a bit of data, with one magnetic orientation representing a “0” and a substantially opposite magnetic orientation representing a “1.” Magnetic recording and read head 22 also includes a read head that is capable of detecting the magnetic fields of the discrete magnetic domains of the magnetic recording layer.

Magnetic data storage media 18 may include a composite magnetic recording layer structure, which is described herein. Some embodiments of the magnetic recording layer may include a top, magnetically soft layer deposited directly on a bottom, magnetically hard layer. As described above, in order to achieve the ECC effect, magnetic orientation switching of the soft layer and the hard layer should be non-coherent. In an ECC magnetic recording layer exhibiting non-coherent magnetic orientation switching, the magnetic orientation of the soft layer begins switching at an applied magnetic field value below an average magnetic anisotropy of the magnetic recording layer (i.e., the average magnetic anisotropy of the soft layer and the hard layer). The nucleation field, which is the magnetic field at which switching of the soft layer begins, depends on the exchange stiffness of the soft layer. The exchange stiffness of the soft layer is a measure of how tightly magnetically coupled the soft layer is to the hard layer, and is inversely proportional to the thickness of the soft layer. In recording media, the total magnetic recording layer thickness may be less than approximately 20 nanometers (nm). The soft layer may be thinner than 13 nm and consequently the nucleation field may be prohibitively high. One solution, which may reduce the nucleation field, is the introduction of an exchange break layer between the hard magnetic layer and the soft magnetic layer.

The exchange break layer may affect the vertical exchange coupling between the top, magnetically soft layer and the bottom, magnetically hard layer, so that the nucleation field required to nucleate switching in the soft part is not prohibitively high, but at the same time, the soft layer is able to exercise a magnetic torque on the hard layer. Thus, the exchange break layer may reduce the overall coercivity of the magnetic recording layer and facilitate recording of data to the magnetic recording layer.

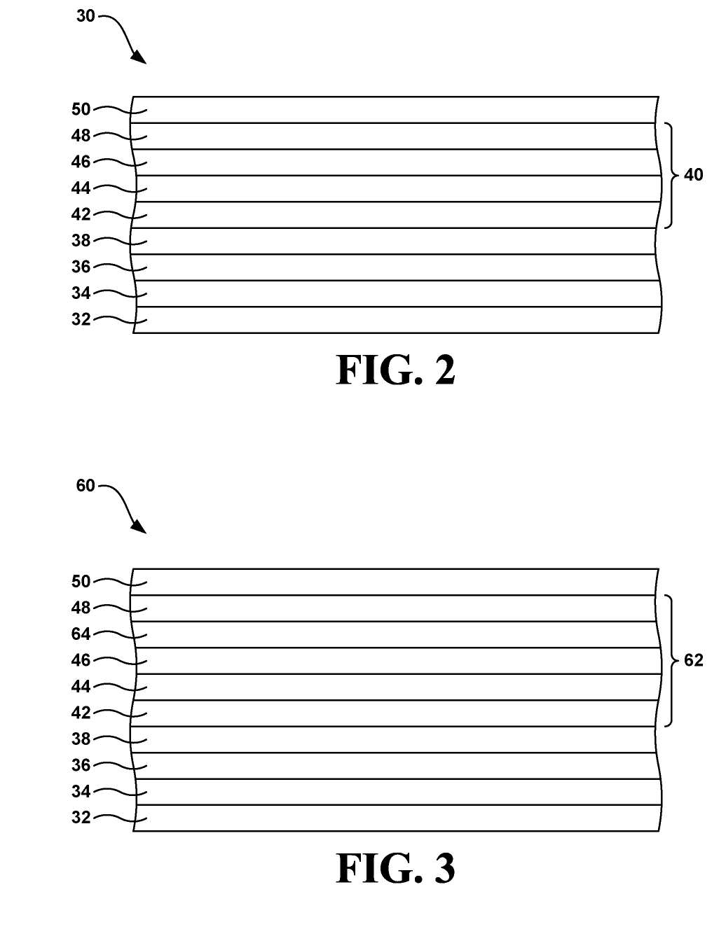

FIG. 2 is a schematic block diagram illustrating an example of a magnetic data storage media 30 including a perpendicular recording layer 40 comprising a hard granular layer 42, an exchange break layer 44, a soft granular layer 46, and a CGC layer 48.

Substrate 32 may include any material that is suitable to be used in magnetic recording media, including, for example, Al, NiP plated Al, glass, ceramic glass, or the like.

Although not shown in FIG. 2, in some embodiments, an additional underlayer may be present immediately on top of substrate 32. The additional underlayer may be amorphous and provides adhesion to the substrate and low surface roughness.

A soft underlayer (SUL) 34 is formed on substrate 32 (or the additional underlayer, if one is present). SUL 34 may be any soft magnetic material with sufficient saturation magnetization (Bₛ) and low magnetic anisotropy (Hₖ). For example, SUL 34 may be an amorphous soft magnetic material such as Ni; Co; Fe; an Fe-containing alloy such as NiFe (Permalloy), FeSiAl, FeSiAlN, or the like; a Co-containing allow such as CoZr, CoZrCr, CoZrNb, or the like; or a CoFe-containing alloy such as CoFeZrNb, CoFe, FeCoB, FeCoC, or the like.

First interlayer 36 and second interlayer 38 may be used to establish an HCP (hexagonal close packed) crystalline orientation that induces HCP (0002) growth of the hard granular layer 42, with a magnetic easy axis perpendicular to the film plane.

Perpendicular recording layer 40 may be formed on second interlayer 38, and includes hard granular layer 42, exchange break layer 44, soft granular layer 46, and CGC layer 48. Hard granular layer 42 may have a higher magnetic anisotropy than soft granular layer 46. The magnetic anisotropies of hard granular layer 42 and soft granular layer 46 may each be oriented in a direction substantially perpendicular to the plane of recording layer 40 (e.g., the easy axes of hard granular layer 42 and soft granular layer 46 may each be substantially perpendicular to the plane of recording layer 40). Exchange break layer 44 may be used to adjust the vertical exchange coupling between hard granular layer 42 and soft granular layer 46.

In some embodiments, each of hard granular layer 42 and soft granular layer 46 may include Co alloys. For example, the Co alloy may include Co in combination with at least one of Cr, Ni, Pt, Ta, B, Nb, O, Ti, Si, Mo, Cu, Ag, Ge, or Fe. The compositions of hard granular layer 42 and soft granular layer 46 may be the same, or may be different. For example, soft granular layer 46 may include a lower percentage of Pt than hard granular layer 42. In some embodiments, at least one of hard granular layer 42 and soft granular layer 46 may include an Fe—Pt alloy, a Sm—Co alloy, or the like. In some embodiments, hard granular layer 42 and/or soft granular layer 46 may include a non-magnetic oxide, such as SiO₂, TiO₂ CoO, Cr₂O₃, Ta₂O₅, or the like, which separates the magnetic grains within the respective layer. In one example, hard granular layer 42 includes a CoCrPt alloy, at least one oxide, and a dopant element, such as Ru, W, Nb, or the like. In one example, soft granular layer 46 includes a CoCrPt alloy, at least one oxide, and a dopant element, such as Ru, W, Nb, or the like. Soft granular layer 42 may include less Pt than hard granular layer 46.

In some embodiments, hard granular layer 42 may have a thickness between approximately 50 Angstroms (Å) and approximately 150 Å. In one embodiment, hard granular layer 42 may have a thickness of approximately 90 Å. In some embodiments, soft granular layer 46 may have a thickness between approximately 20 Å and approximately 100 Å. In one embodiment, soft granular layer 46 may have a thickness of approximately 40 Å. Of course, other thicknesses for hard granular layer 42 and soft granular layer 46 are also contemplated.

A protective overcoat 50, such as, for example, diamond like carbon, may be formed over recording layer 40. In other examples, protective overcoat 50 may include, for example, an amorphous carbon layer that further includes hydrogen, nitrogen, or the like.

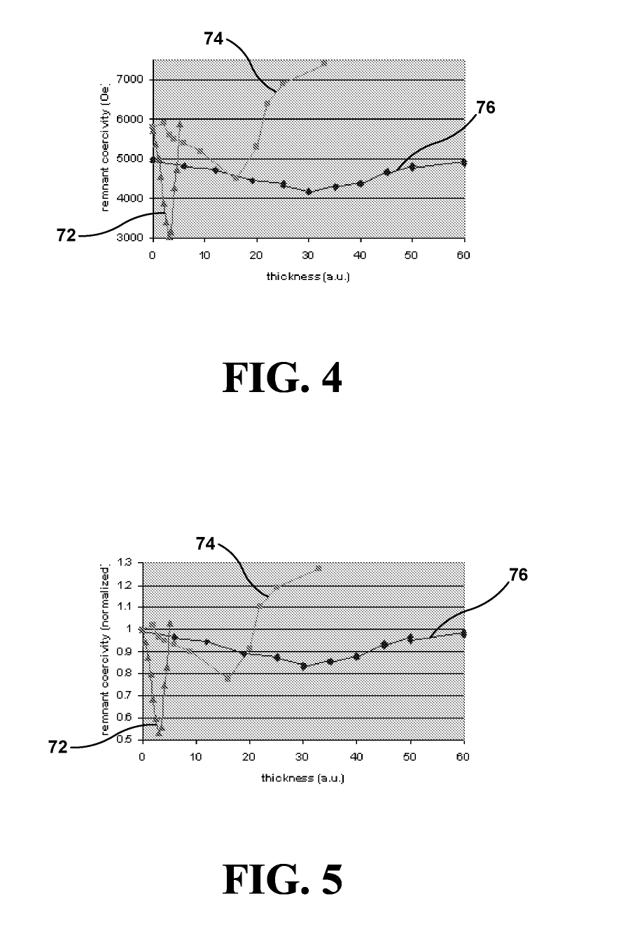

The dependence of magnetic coercivity on the thickness of exchange break layer 44 may have a ‘V’ shape, as shown in FIGS. 3 and 4. Coercivity of recording layer 40 may decrease when exchange break layer 44 is added between the hard and soft granular layers 42 and 46 and reaches a minimum, after which coercivity of recording layer 40 starts increasing. The coercivity increase occurs when the hard and soft granular layers 42 and 46 are overly vertical exchange-decoupled, and once hard and soft granular layers 42 and 46 are substantially fully vertical exchange-decoupled, the coercivity of the composite structure approaches the coercivity of the hard granular layer 42, which is higher. The magnetic recording layer 40 with the exchange break layer 44 which corresponds to the bottom of the ‘V’ curve shows the greatest deviation from the Stoner-Wohlfarth curve, i.e., the magnetic recording layer 40 demonstrates the most non-coherent magnetic orientation switching of the tested samples.

Composite magnetic recording layers as described herein may provide improved write-ability (e.g., magnetic coercivity of recording layer 40 is decreased) compared to some magnetic recording media of similar magnetic stability (KᵤV/kT). Most importantly, vertical exchange coupling, as utilized in magnetic recording layer 40 of the current disclosure, may not increase the in-plane intra-granular exchange interaction (i.e., lateral exchange coupling); thus, write-ability of recording layer 40 may be decoupled from in-plane magnetic exchange coupling in the currently described magnetic recording layer 40.

Exchange break layer 44 can vary in composition, from weakly magnetic to non-magnetic. In embodiments in which exchange break layer 44 consists essentially of or consists of ruthenium, the minimum of the ‘V’ shape curve may be obtained for an exchange break layer 44 having a thickness of less than 3 Å, as will be described below with reference to FIGS. 4 and 5. In some examples, break layer 44 may consist essentially of or consist of ruthenium. In the context of the present application, “consists essentially of” means that a structure includes substantially only the component listed, but may include small amount of impurities present in commercially available sources of the component, or relatively small amounts of components from adjacent structures or layers which have diffused into the structure during manufacture, processing, or use. In case of an exchange break layer 44 that comprises ruthenium and cobalt, the maximum decrease in coercivity may be obtained for a thickness between 10 Å and 15 Å (see curve 74 in FIGS. 4 and 5 below). An exchange break layer 44 comprising a thickness between approximately 1 Å and approximately 2 Å may be advantageous, even though such a break layer 44 may lead to manufacturing challenges. A thin exchange break layer 44 allows a ratio of the thickness of hard granular layer 42 in the thickness of recording layer 40 to be increased, increasing the magnetic anisotropy energy of magnetic recording layer 40.

Magnetic recording layer 40 may still include CGC layer 48 on top of soft granular layer 46 to reduce the slope of the MH loop by the addition of lateral (in-plane) magnetic exchange interaction. However, since write-ability is sufficiently addressed by the ECC effects between soft granular layer 46 and hard granular 42, a thickness of CGC layer 48 can be reduced. Reduction of the thickness of CGC layer 48 may reduce lateral exchange coupling among adjacent grains of magnetic recording layer 40, which, in turn, may reduce clustering of magnetic orientation of adjacent grains.

CGC layer 48 may comprise, for example, CoCrPtBZ, where Z is a metal or rare earth element dopant, such as Ru, W, Nb, or the like. In some embodiments, CGC layer 48 may have a thickness of approximately 90 Å. In some embodiments, CGC layer 48 may include a small amount of an oxide, such as SiOₓ, TiOₓ, TaOₓ, WO_{N}, NbOₓ, CrOₓ, CoOₓ, or the like. In other embodiments, CGC layer 48 may not include an oxide.

Thus, in one embodiment, the full stack of magnetic recording layer 40 proposed herein includes hard granular layer 42, exchange break layer 44, soft granular layer 46, and CGC layer 48.

In some embodiments, the magnetic anisotropy values of the three magnetic layers (hard granular layer 42, soft granular layer 46, and CGC layer 48) may decrease from the hard granular layer 42 to CGC layer 48. Thus, hard granular layer 42 may have the highest magnetic anisotropy, soft granular layer 46 may have an intermediate magnetic anisotropy, and CGC layer 48 may have the lowest magnetic anisotropy. The actual magnetic anisotropy values used in the three layers and the thickness of break layer 44 may be selected such that the resulting magnetic recording layer 40 matches the given head field, e.g., is writeable at a magnetic field that magnetic recording and read head 22 (FIG. 1) is able to produce. In some embodiments, the magnetic anisotropy value of hard granular layer 42 may be between approximately 15 kOe and approximately 35 kOe, the magnetic anisotropy value of soft granular layer 46 may be between approximately 4 kOe and approximately 15 kOe, and the magnetic anisotropy value of CGC layer 48 may be between approximately 6 kOe and approximately 20 kOe.

Although recording layer 40 may have graded magnetic anisotropy values, in that the value of the magnetic anisotropy energy of the magnetic layers in recording layer 40 decreases monotonically from the bottom to the top of the recording layer 40, other constraints may limit the choice of materials for CGC layer 48. For example, mechanical strength of the film may require a CGC layer 48 whose magnetic anisotropy value is relatively high (e.g., higher than the anisotropy of soft granular layer 46 but lower than the anisotropy of hard granular layer 42). In this case, soft granular layer 46, of low anisotropy, is sandwiched between a hard granular layer 42, of high anisotropy, and a continuous layer 48, of a somewhat higher anisotropy than soft granular layer 46. In such an embodiment, the magnetization orientation of soft granular layer 46 may be ‘pinned’ to its neighbors' magnetization orientation, and the magnetization orientation of soft granular layer 46 cannot rotate incoherently; the strength of the ECC effect may be reduced or extinguished.

In some embodiments, as shown in FIG. 3, a recoding medium 60 may include a recording layer 62 that has a hard granular layer 42, a first exchange break layer 44 formed on hard granular layer 42, a soft granular layer 46 formed on first exchange break layer 44, a second exchange break layer 64 formed on soft granular layer 46, and a CGC layer 48 formed on second exchange break layer 64. Second exchange break layer 64 separates soft granular layer 46 and CGC layer 48 so that the low anisotropy of soft granular layer 46 is not averaged with the magnetic anisotropy of CGC layer 48, which may be higher than the magnetic anisotropy of soft granular layer 46. This may increase the contrast in magnetic anisotropy values between soft granular layer 46 and hard granular layer 44 compared to a recording layer having a CGC layer 48 immediately adjacent to soft granular layer 46. An increased contrast in magnetic anisotropy may enhance the ECC effect.

In some embodiments, second exchange break layer 64 may comprise ruthenium or a ruthenium alloy. In some embodiments, second exchange break layer 64 may consist of or consist essentially of ruthenium. In other embodiments, second exchange break layer 64 may include cobalt-chromium-based non- or weakly-magnetic alloy, such as, for example, a CoCr alloy, a CoRu alloy, or a CoCrRu alloy. Second exchange break layer 64 may optionally include a non-magnetic oxide, such as, for example, SiO₂, TiO₂CoO, Cr₂O₃, Ta₂O₅, or the like. A second exchange break layer 64 including a non-magnetic oxide may facilitate subsequent deposition of soft granular layer 46.

By introducing exchange break layer 44 between the hard granular layer 42 at the bottom of the recording layer 40 and the layers on top of hard granular layer 42 (which have relatively lower anisotropy than hard granular layer 42) recording layer 40 may become easier to write (i.e., have a lower effective coercivity). The increased ease of recording data to magnetic recording layer 40 may be achieved through the ECC effect, in which the magnetically softer layers (e.g., CGC layer 48 and soft granular layer 46) at the top of recording layer 40 begin to switch magnetic orientations before hard granular layer 42 begins to switch magnetic orientations when a recording field is applied. The softer layers then exercise a magnetic torque on the hard granular layer 42, thus reducing the effective coercivity of magnetic recording layer 40. The reduction of the effective coercivity with thickness of break layer 44 is shown in FIGS. 4 and 5.

The strongest reduction in coercivity is observed when ‘Non-Co alloy’ is used for exchange break layer 44 (exchange break layer 44 consists of Ruthenium; curve 72 in FIGS. 4 and 5), where remnant coercivity decreases to about 50% of the value when no exchange break layer 44 is present. For comparison, when other exchange break layers 44 are used, with various Cobalt-containing compositions, the maximum coercivity reduction is about 20% compared to the coercivity when no exchange break layer 44 is present (the sample represented by curve 76 in FIGS. 4 and 5 comprises a CoCrPtBCu alloy, the sample represented by curve 74 in FIGS. 4 and 5 comprises a CoCrRu oxide alloy). Similar to described above with respect to FIG. 2, each of the samples represented in FIGS. 4 and 5 included a hard granular layer 42 that included a CoCrPt alloy, at least one oxide, and a dopant element, such as Ru, W, Nb, or the like. A thickness of hard granular layer 42 in each of the samples was between approximately 50 Å and approximately 150 Å. Each of the samples represented by curves 72, 74, 76 in FIGS. 4 and 5 also included a soft granular layer 46 that included a CoCrPt alloy, at least one oxide, and a dopant element, such as Ru, W, Nb, or the like. A thickness of soft granular layer 46 was between approximately 20 Å and approximately 100 Å. Additionally, each of the samples included a CGC layer 48 comprising a CoCrPtB alloy doped with at least one of Ru, W, Nb. A thickness of CGC layer 48 was between approximately 20 Å and approximately 150 Å.

After exchange break layer 44 reaches a certain thickness (e.g., about 3 a.u. for curve 72, about 15 a.u. for curve 74, about 30 a.u. for curve 76), the vertical magnetic exchange coupling between the top soft layers (soft granular layer 46 and CGC layer 48) and hard granular layer 42 begins to decrease, and the ECC effect decreases. In other words, the remnant coercivity of hard layer 42 begins to have a larger contribution to the write coercivity of magnetic recording layer 40 for the purposes of recording data to magnetic recording layer 40, because the soft layers 46 and 48 have relatively low coercivity by themselves and contribute to less to the remnant coercivity of recording layer 40. Accordingly, the remnant coercivity of recording layer 40 as a whole increases, and the curves 72, 74, 76 have a ‘V’ shape.

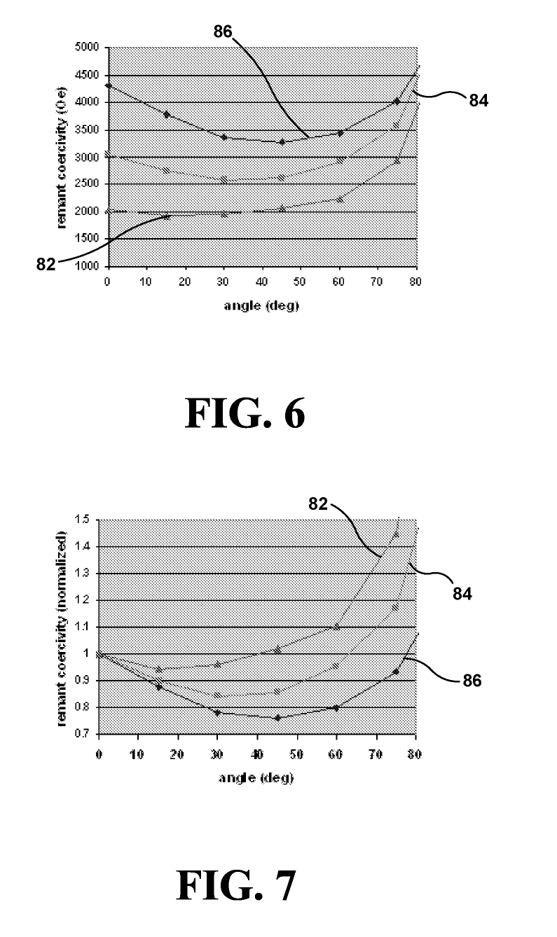

The ECC effect is based on the non-coherent reversal of the hard granular layer 42 and soft layers (soft granular layer 46 and CGC layer 48): under an external magnetic field of sufficient strength, the soft layers 46 and 48 begin to switch magnetic orientations first, followed by switching of the magnetic orientation of hard granular layer 42. This behavior is significantly different from that of CGC media, where all magnetic layers in the recording layer switch magnetic orientations coherently, substantially simultaneously. The deviation from coherent magnetic orientation switching due to the ECC effect can be evaluated by measuring the remnant coercivity dependence on the angle of the applied magnetic field relative to the easy axis of the magnetic grains, examples of which are shown in FIGS. 6 and 7. When switching of magnetic orientation of the layers in magnetic recording layer 40 is coherent, as for CGC media, the magnetic field necessary to switch the magnetic orientation of grains in magnetic recording layer 40 is maximum when the external field is parallel to the easy axis of the grains (0 degrees in FIGS. 6 and 7), and minimum when the applied field angle is 45 degrees (shown by curve 86). In theory, this is described by the Stoner-Wohlfarth curve, and the minimum coercivity should be equal to 0.5 of the maximum coercivity. For CGC media, FIGS. 6 and 7 illustrate the minimum coercivity (at 45 degrees) is about 0.75 of the maximum coercivity (at 0 deg); the difference between the observed coercivity decrease and the theoretical coercivity decrease is due to the dispersion in the orientations of the easy axes of the grains.

In ECC media, as described herein, the use of exchange break layer 44 between hard granular layer 42 and soft granular layer 46 results in deviation from the Stoner-Wohlfarth curve: remnant coercivity is less dependent on the applied field angle at small angles. This is indicated by the relative flatness of the remnant coercivity versus applied field angle curves 82 and 84 illustrated in FIGS. 6 and 7. For example, curves 82 and 84 for recording layers including a break layer show less dependence of remnant coercivity on the applied field angles for applied field angles of less than approximately 60 degrees than the curve 86 for a CGC recording layer. FIGS. 6 and 7 also illustrate that the remnant coercivity of the recording layers including a break layer 44 increases considerably when the field is applied at 90 degrees (in the plane of the recording layer 40; see curves 82 and 84). This behavior was predicted by theory for ECC recording layers and supports the incoherent magnetic orientation reversal of a recording layer 40 including a break layer 44 between a hard granular layer 42 and a soft granular layer 44.

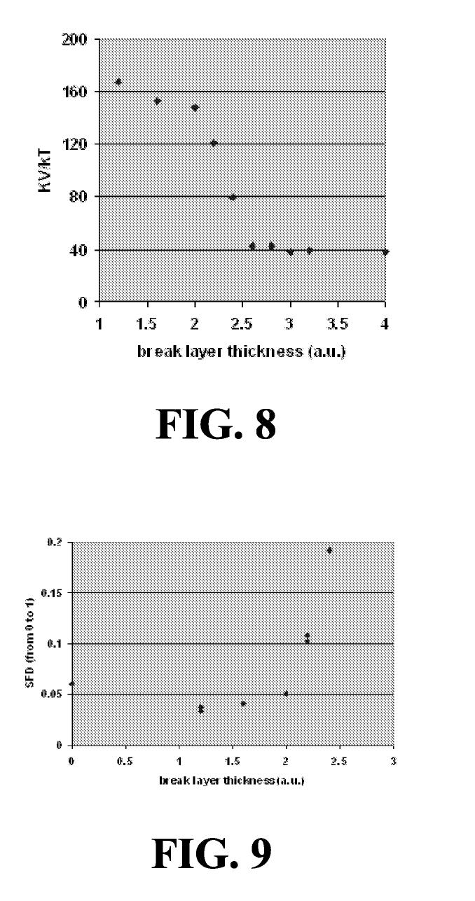

Magnetic recording media with exchange break layer 44 may offer increased write-ability (lower effective coercivity) compared to CGC media, while maintaining acceptable thermal stability. FIG. 8 shows that the energy barrier (KᵤV/kT) is not substantially decreased by the introduction of an exchange break layer 44 consisting essentially of ruthenium between hard granular layer 42 and soft granular layer 46 until the thickness of exchange break layer 44 is greater than about 2 a.u. Accordingly, an exchange break layer 44 consisting essentially of ruthenium and having a thickness between 0 and about 2 a.u. may be used in recording layer 40, as magnetization orientation switching due to thermal fluctuations is not a significant concern.

Each of the samples represented in FIG. 8 included a hard granular layer 42 that included a CoCrPt alloy, at least one oxide, and a dopant element, such as Ru, W, Nb, or the like. A thickness of hard granular layer 42 in each of the samples was between approximately 50 Å and approximately 150 Å. Each of the samples represented in FIG. 8 also included a soft granular layer 46 that comprised a CoCrPt alloy, at least one oxide, and a dopant element, such as Ru, W, Nb, or the like. A thickness of soft granular layer 46 was between approximately 20 Å and approximately 100 Å. Additionally, each of the samples included a CGC layer 48 comprising a CoCrPtB alloy doped with at least one of Ru, W, Nb. A thickness of CGC layer 48 was between approximately 20 Å and approximately 150 Å.

A desirable thickness of the exchange break layer 44 for a particular recording layer 40 may be determined from measurement of a switching field distribution (SFD). As FIG. 9 shows, the SFD improves slightly when the vertical exchange coupling between the hard granular layer 42 and soft granular layer 46 improves (thickness of between 0 and about 2 a.u. for an exchange break layer 44 consisting essentially of ruthenium). As the thickness of exchange break layer 44 increases further, the vertical exchange coupling between hard granular layer 42 and soft granular layer 46 begins to decrease and the ensemble of grains splits into two distributions, one distribution formed by grains in hard granular layer 42, a second distribution formed by grains in soft granular layer 46. When trying to fit this bi-modal distribution by a single SFD, a large value is obtained. A sudden ‘jump’ in SFD indicates such decoupling, and occurs at about 2 a.u. for an exchange break layer 44 consisting essentially of ruthenium, as shown in FIG. 9.

Each of the samples represented in FIG. 9 included a hard granular layer 42 that included a CoCrPt alloy, at least one oxide, and a dopant element, such as Ru, W, Nb, or the like. A thickness of hard granular layer 42 in each of the samples was approximately 90 Å. Each of the samples represented in FIG. 9 also included a soft granular layer 46 that comprised a CoCrPt alloy, at least one oxide, and a dopant element, such as Ru, W, Nb, or the like. A thickness of soft granular layer 46 was approximately 40 Å. Additionally, each of the samples included a CGC layer 48 comprising a CoCrPtB alloy doped with at least one of Ru, W, Nb. A thickness of CGC layer 48 was approximately 90 Å.

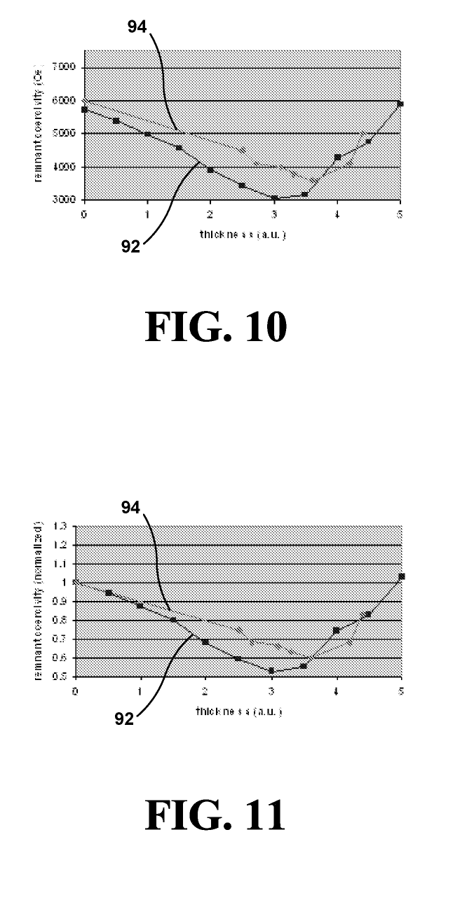

FIGS. 10 and 11 illustrate results of a comparison of the effect of break layer thickness on two designs of a recording layer. Curve 94 illustrates results for a recording layer 40 having a hard granular layer 42/break layer 44/CGC layer 48 structure. Hard granular layer 42 included a CoCrPt alloy, at least one oxide, and a dopant element, such as Ru, W, Nb, or the like, and had a thickness of 90 Å. CGC layer 48 comprised a CoCrPtB alloy doped with at least one of Ru, W, Nb, and had a thickness of approximately 90 Å. The recording layer 40 represented by curve 94 does not include a soft granular layer 46. Curve 92 illustrates results for a recording layer 40 having a hard granular layer 42/break layer 44/soft granular layer 46/CGC layer 48. Hard granular layer 42 included a CoCrPt alloy, at least one oxide, and a dopant element, such as Ru, W, Nb, or the like, and had a thickness of 90 Å. Soft granular layer 46 comprised a CoCrPt alloy, at least one oxide, and a dopant element, such as Ru, W, Nb, or the like, and had a thickness of approximately 40 Å. CGC layer 48 comprised a CoCrPtB alloy doped with at least one of Ru, W, Nb, and had a thickness of approximately 90 Å.

FIGS. 10 and 11 show that a similar reduction of coercivity (translating into easier recording of information to recording layer 40) occurs at smaller thicknesses of exchange break layer 44 for curve 92, i.e., when a soft granular layer 46, is present. The ECC effect appears when the grains themselves are composite, in the sense that each grain has a magnetically hard bottom vertically exchange coupled to a magnetically soft top. The minimum of the remnant coercivity curve is also greater in curve 94, when a soft granular layer 46 is not present, meaning the reduction in coercivity is not as great (about 40% remnant coercivity reduction instead of about 50% remnant coercivity reduction).

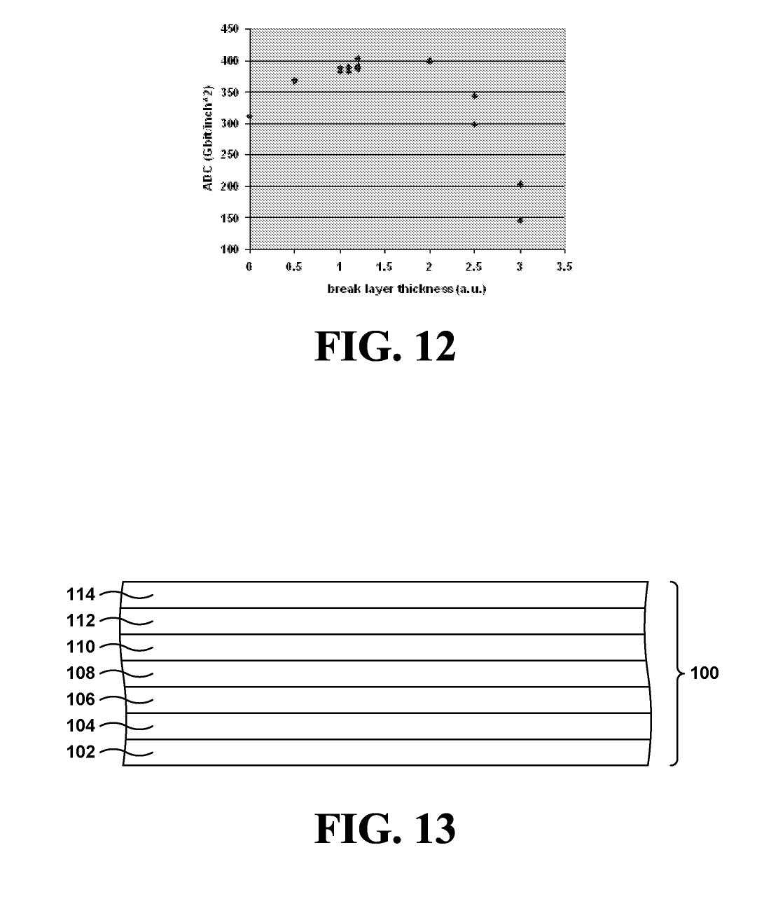

The write-ability improvement (accompanied by acceptable thermal stability) offered by a recording layer 40 including an exchange break layer 44 may enable better recording system performance in at least one of at least two ways. First, narrower heads can be used to record data to such a recording layer 40. While narrower heads may produce an applied field of lower magnitude, recording layer 40 may still be write-able due to the ECC effect produced by hard granular layer 42, exchange break layer 44, and soft granular layer 44. Narrower heads may enable higher areal densities by writing the data tracks closer together. As shown in FIG. 12, ADC (areal density capability) shows that a recording layer 40 including an exchange break layer 44 with certain thicknesses (less than approximately 2.5 a.u. for ruthenium) may provide better performance than the reference, which does not include an exchange break layer.

Each of the samples represented in FIG. 9 included a hard granular layer 42 that included a CoCrPt alloy, at least one oxide, and a dopant element, such as Ru, W, Nb, or the like. A thickness of hard granular layer 42 in each of the samples was approximately 90 Å. Each of the samples represented in FIG. 9 also included a soft granular layer 46 that comprised a CoCrPt alloy, at least one oxide, and a dopant element, such as Ru, W, Nb, or the like. A thickness of soft granular layer 46 was approximately 40 Å. Additionally, each of the samples included a CGC layer 48 comprising a CoCrPtB alloy doped with at least one of Ru, W, Nb. A thickness of CGC layer 48 was approximately 90 Å.

Second, the fact that the ‘Non-Co alloy’ (ruthenium) exchange break layer 44 consisting essentially of ruthenium may be extremely thin relative to an exchange break layer 44 including a Co alloy may allow use of a thicker hard granular layer 42 compared to a recording layer 40 including an exchange break layer 44 including a Co alloy. For example, thickness of hard granular layer 42 (“HGL Thickness” in Table 1) can be increased from 90 Å to 120 Å, and while maintaining the total thickness of recording layer 40 below 200 Å. A thicker hard granular layer 42 results in a higher thermal energy barrier (KᵤV) compared to a thinner hard granular layer 42 of the same anisotropy. In this way, a thicker hard granular layer 42 can improve erasure-related issues, such as, for example, adjacent track interference, mechanical scratch resistance, or the like. The following Table 1 shows three recording layers with increasing thickness of hard granular layer 42, higher KᵤV values (improved thermal stability), and other performance metrics (Writability—more negative is better and SNR—higher is better) substantially equal to the reference recording layer.

TABLE 1

| | HGL | CGC | | | | | |
|---|---|---|---|---|---|---|---|
| | Thick- | Thick- | | | | Writ- | |
| | ness | ness | H_{c} | Hₙᵣ | | ability | SNR |
| | (Å) | (Å) | (Oe) | (Oe) | KᵤV/kT | (dB) | (dB) |
| Reference | | | | | | −29.30 | 15.72 |
| Sample 1A | 95 | 60 | 4577 | 2032 | 88 | −27.87 | 15.82 |
| Sample 1B | 95 | 60 | 4571 | 2022 | 88 | −28.53 | 15.93 |
| Sample 2A | 80 | 70 | 4547 | 2082 | 113 | −32.68 | 16.10 |
| Sample 2B | 80 | 70 | 4533 | 2037 | 113 | −32.11 | 16.13 |
| Sample 3A | 120 | 80 | 4568 | 2136 | 122 | −33.21 | 15.89 |
| Sample 3B | 120 | 80 | 4552 | 2069 | 122 | −32.80 | 16.05 |

Although the embodiments described above include one exchange break layer 44 or a first exchange break layer 44 and a second exchange break layer 64, in some embodiments, a recording layer may include three or more exchange break layers. For example, FIG. 13 illustrates a recording layer 100 including a hard granular layer 102, a first exchange break layer 104, an intermediate granular layer 106, a second exchange break layer 108, a soft granular layer 110, a third exchange break layer 112, and a CGC layer 114.

Hard granular layer 102 may be similar in composition and/or thickness to hard granular layer 42. The magnetic anisotropy of hard granular layer 102 may be oriented in a direction substantially perpendicular to the plane of recording layer 100 (e.g., the easy axes of grains in hard granular layer 102 may be substantially perpendicular to the plane of recording layer 100). Hard granular layer 102 may comprise, for example, a Co alloy. The Co alloy may include Co in combination with at least one of Cr, Ni, Pt, Ta, B, Nb, O, Ti, Si, Mo, Cu, Ag, Ge, or Fe. In some embodiments, hard granular layer 102 may include an Fe—Pt alloy, a Sm—Co alloy, or the like. Hard granular layer 102 may include a non-magnetic oxide, such as SiO₂, TiO₂CoO, Cr₂O₃, Ta₂O₅, or the like, which separates the magnetic grains within the hard granular layer 102 and reduces lateral magnetic coupling between the grains in hard granular layer 102.

First exchange break layer 104 may be formed on hard granular layer 102, and may comprise ruthenium or a ruthenium alloy. As described above, in some embodiments, first exchange break layer 104 may consist essentially of or consist of ruthenium. A first exchange break layer 104 consisting essentially of ruthenium may provide similar vertical exchange coupling between hard granular layer 102 and intermediate granular layer 106 at a lower thickness than a first exchange break layer 104 comprising a ruthenium alloy. For example, a first exchange break layer 104 consisting essentially of ruthenium may provide desirable vertical exchange coupling at a thickness less than approximately 3 Å. In embodiments in which exchange break layer 104 comprises a ruthenium alloy, first exchange break layer 104 may include, for example, a CoₓRu₁₋ₓ alloy. A first exchange break layer 104 including a ruthenium alloy may have a greater thickness, such as, for example, between 0 Å and approximately 60 Å. In some embodiments, a first exchange break layer 104 including a ruthenium alloy may have a thickness between approximately 10 Å and approximately 30 Å. In addition to Ru or a CoₓRu₁₋ₓ alloy, exchange break layer 104 may optionally include a non-magnetic oxide, such as, for example, SiO₂, TiO₂CoO, Cr₂O₃, Ta₂O₅, or the like. A first exchange break layer 104 including a non-magnetic oxide may facilitate subsequent deposition of intermediate granular layer 106.

Intermediate granular layer 106 is formed on first exchange break layer 104 and may include a plurality of grains that have a magnetic anisotropy oriented in a direction substantially perpendicular to the plane of recording layer 100 (e.g., the easy axes of grains in intermediate granular layer 106 may be substantially perpendicular to the plane of recording layer 100). Intermediate granular layer 106 may comprise, for example, a Co alloy. The Co alloy may include Co in combination with at least one of Cr, Ni, Pt, Ta, B, Nb, O, Ti, Si, Mo, Cu, Ag, Ge, or Fe. In some embodiments, intermediate granular layer 106 may include an Fe—Pt alloy, a Sm—Co alloy, or the like. Intermediate granular layer 106 may include a non-magnetic oxide, such as SiO₂, TiO₂CoO, Cr₂O₃, Ta₂O₅, or the like, which separates the magnetic grains within the intermediate granular layer 106 and reduces lateral magnetic coupling between the grains in intermediate granular layer 106.

Intermediate granular layer 106 may have a different composition than hard granular layer 102. In some embodiments, the composition of intermediate granular layer 106 results in intermediate granular layer 106 having a magnetic anisotropy value lower than that of hard granular layer 102.

Second exchange break layer 108 is formed on intermediate granular layer 106, and may comprise ruthenium or a ruthenium alloy. In some embodiments, second exchange break layer 108 may include a similar composition as first exchange break layer 104, while in other embodiments, second exchange break layer 108 may include a different composition than first exchange break layer 104. For example, in some embodiments, second exchange break layer 108 may consist essentially of or consist of ruthenium. A second exchange break layer 108 consisting essentially of ruthenium may provide similar vertical exchange coupling between intermediate granular layer 106 and soft granular layer 110 at a lower thickness than a second exchange break layer 108 comprising a ruthenium alloy. For example, a second exchange break layer 108 consisting essentially of ruthenium may provide desirable vertical exchange coupling at a thickness less than approximately 3 Å. In embodiments in which second exchange break layer 108 comprises a ruthenium alloy, second exchange break layer 108 may include, for example, a CoₓRu₁₋ₓ alloy. A second exchange break layer 108 including a ruthenium alloy may have a greater thickness, such as, for example, between 0 Å and approximately 60 Å. In some embodiments, a second exchange break layer 108 including a ruthenium alloy may have a thickness between approximately 10 Å and approximately 30 Å. In addition to Ru or a CoₓRu₁₋ₓ alloy, second exchange break layer 108 may optionally include a non-magnetic oxide, such as, for example, SiO₂, TiO₂CoO, Cr₂O₃, Ta₂O₅, or the like. A second exchange break layer 108 including a non-magnetic oxide may facilitate subsequent deposition of soft granular layer 110.

Soft granular layer 110 is formed on second exchange break layer 108 and may include a plurality of grains that have a magnetic anisotropy oriented in a direction substantially perpendicular to the plane of recording layer 100 (e.g., the easy axes of grains in soft granular layer 110 may be substantially perpendicular to the plane of recording layer 100). In some embodiments, soft granular layer 110 comprises a Co alloy including Co in combination with at least one of Cr, Ni, Pt, Ta, B, Nb, O, Ti, Si, Mo, Cu, Ag, Ge, or Fe. In other embodiments, soft granular layer 110 includes an Fe—Pt alloy, a Sm—Co alloy, or the like. Soft granular layer 110 may include a non-magnetic oxide, such as SiO₂, TiO₂CoO, Cr₂O₃, Ta₂O₅, or the like, which separates the magnetic grains within the soft granular layer 110 and reduces lateral magnetic coupling between the grains in soft granular layer 110.

Soft granular layer 110 may have a different composition than hard granular layer 102 and/or intermediate granular layer 106. In some embodiments, the composition of soft granular layer 110 results in soft granular layer 110 having a magnetic anisotropy value lower than those of intermediate granular layer 106 and hard granular layer 102.

Third exchange break layer 112 is formed on soft granular layer 110, and may comprise ruthenium or a ruthenium alloy, similar to first and second exchange break layer 104 and 108. In some embodiments, third exchange break layer 112 may include a similar composition as first exchange break layer 104 and/or second exchange break layer 108, while in other embodiments, third exchange break layer 112 may include a different composition than first exchange break layer 104 and second exchange break layer 108. For example, third exchange break layer 112 may consist essentially of or consist of ruthenium, or may comprise a ruthenium alloy, e.g., CoₓRu₁₋ₓ. In addition to Ru or a CoₓRu₁₋ₓ alloy, third exchange break layer 112 may optionally include a non-magnetic oxide, such as, for example, SiO₂, TiO₂CoO, Cr₂O₃, Ta₂O₅, or the like.

CGC layer 114 is formed on top of third exchange break layer 112, in order to reduce the slope of the MH loop by the addition of lateral (in-plane) magnetic exchange interaction in recording layer 100. However, since write-ability is sufficiently addressed by the ECC effects between soft granular layer 110, intermediate granular layer 106, and hard granular layer 102, a thickness of CGC layer 114 can be reduced. Reduction of the thickness of CGC layer 114 may reduce lateral exchange coupling among adjacent grains of magnetic recording layer 100, which, in turn, may reduce clustering of magnetic orientation of adjacent grains.

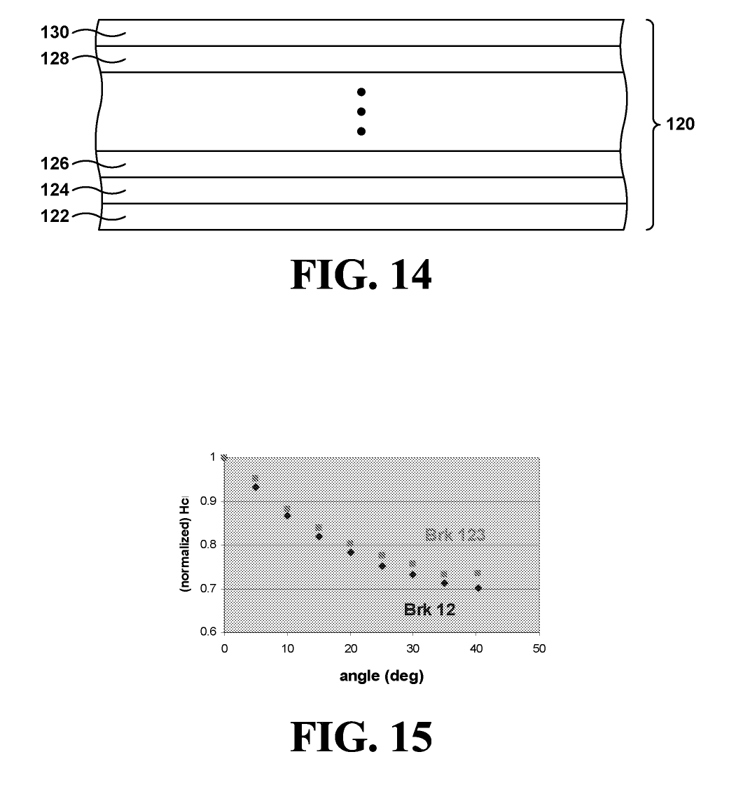

In general, the concept of exchange break layers and a plurality of granular magnetic layers having a magnetic anisotropy gradient may be extended to an arbitrary number of layers. For example, as shown in FIG. 14, a magnetic recording layer 120 may include (2n−1) layers, including n magnetic layers alternating with n−1 exchange break layers, where n is an integer greater than or equal to 3. In particular, FIG. 14 illustrates a first magnetic layer 122, which may be a granular magnetic layer with relatively high magnetic anisotropy (e.g., the highest magnetic anisotropy of any magnetic layer in recording layer 120). The magnetic anisotropy of first magnetic layer 122 is oriented in a direction substantially perpendicular to the plane of recording layer 120 (e.g., the easy axes of grains in first magnetic layer 122 may be substantially perpendicular to the plane of recording layer 120). First magnetic layer 122 may comprise a Co alloy, an Fe—Pt alloy, a Sm—Co alloy, or the like, and may include a non-magnetic oxide, such as, SiO₂, TiO₂CoO, Cr₂O₃, Ta₂O₅, or the like, as described above.

First exchange break layer 124 is formed on first magnetic layer 122. First exchange break layer 124 may comprise ruthenium or a ruthenium alloy. In some embodiments, first exchange break layer 124 may consist essentially of or consist of ruthenium, while in other embodiments, first exchange break layer 124 may comprise a ruthenium alloy, e.g., CoₓRu₁₋ₓ. In addition to Ru or a CoₓRu₁₋ₓ alloy, first exchange break layer 124 may optionally include a non-magnetic oxide, such as, for example, SiO₂, TiO₂CoO, Cr₂O₃, Ta₂O₅, or the like.

Second magnetic layer 126 is formed on first exchange break layer 124, and may be a granular magnetic layer with magnetic anisotropy that is relatively high, but less than the magnetic anisotropy of first magnetic layer 122. The magnetic anisotropy of second magnetic layer 126 is oriented in a direction substantially perpendicular to the plane of recording layer 120 (e.g., the easy axes of grains in second magnetic layer 126 may be substantially perpendicular to the plane of recording layer 120). Second magnetic layer 126 may comprise a Co alloy, an Fe—Pt alloy, a Sm—Co alloy, or the like, and may include a non-magnetic oxide, such as, SiO₂, TiO₂CoO, Cr₂O₃, Ta₂O₅, or the like, as described above. The composition of second magnetic layer 126 may be different than the composition of first magnetic layer 122, such that second magnetic layer 126 has a lower magnetic anisotropy value that first magnetic layer 122. For example, second magnetic layer 126 may include similar components as first magnetic layer 122, but in different proportions.

Recording layer 120 may include an arbitrary of magnetic layers and exchange break layers in an alternating pattern. Each subsequent magnetic layer may have a lower magnetic anisotropy than the magnetic layer before it. For example, magnetic layer n−2 (not shown) may have a lower magnetic anisotropy than magnetic layer n−3 (not shown). Exchange break layer n−1 128 is formed on magnetic layer n−1. Exchange break layer n−1 128 may comprise ruthenium or a ruthenium alloy, and may have a similar composition to first exchange break layer 124 or a different composition than first exchange break layer 124. In some embodiments, exchange break layer n−1 128 may consist essentially of or consist of ruthenium, while in other embodiments, exchange break layer n−1 128 may comprise a ruthenium alloy, e.g., CoₓRu₁₋ₓ. In addition to Ru or a CoₓRu₁₋ₓ alloy, exchange break layer n−1 128 may optionally include a non-magnetic oxide, such as, for example, SiO₂, TiO₂ CoO, Cr₂O₃, Ta₂O₅, or the like.

Magnetic layer n 130 is formed on exchange break layer n−1 128, and in some embodiments may be a granular magnetic layer with magnetic anisotropy that is relatively low, e.g., lower than the magnetic anisotropy of any other of the magnetic layers in recording layer 120. In embodiments in which magnetic layer n is a granular magnetic layer, the magnetic anisotropy of magnetic layer n 130 is oriented in a direction substantially perpendicular to the plane of recording layer 120 (e.g., the easy axes of grains in magnetic layer n 130 may be substantially perpendicular to the plane of recording layer 120). Magnetic layer n 130 may comprise a Co alloy, an Fe—Pt alloy, a Sm—Co alloy, or the like, and may include a non-magnetic oxide, such as, SiO₂, TiO₂CoO, Cr₂O₃, Ta₂O₅, or the like, as described above. The composition of magnetic layer n 130 may be different than the composition of first magnetic layer 122 and/or second magnetic layer 126, such that magnetic layer n 130 has a lower magnetic anisotropy value than first magnetic layer 122 and second magnetic layer 126. For example, magnetic layer n 130 may include similar components as first magnetic layer 122 and/or second magnetic layer 126, but in different proportions. While not shown in FIG. 14, in some embodiments in which magnetic layer n 130 is a granular magnetic layer, recording layer 120 may include a CGC layer formed on magnetic layer n. The CGC layer may be similar to those described above with reference to FIGS. 2, 3, and 13.

In some embodiments, magnetic layer n 130 may comprise a CGC layer, similar to CGC layer 48 described with reference to FIGS. 2 and 3 or CGC layer 114 described with reference to FIG. 13.

An increased number of magnetic layers and exchange break layers in recording layer 120 may provide improved recording and/or read performance compared to a recording layer with fewer magnetic layers and/or exchange break layers, as shown in FIG. 15. FIG. 15 is a plot of the normalized coercivity, H_{c}, of a magnetic recording layer as a function of the angle of an applied magnetic field. FIG. 15 illustrates experimental data obtained for a recording layer 120 including seven layers, of which four are magnetic layers and three are exchange break layers, and for a recording layer 120 including five layers, of which three are magnetic layers and two are exchange break layers. The angular dependence of the coercivity for the recording layer 120 including seven layers is decreased compared to the angular dependence of the coercivity for the recording layer including five layers. This, along with the improved bit error rate and improved ADC shown in Table 2, indicates that a seven layer recording layer may provide improved performance compared to a five layer recording layer.

TABLE 2

| | H_{c} | Hn | Head | Bit Error Rate | Calculated |
|---|---|---|---|---|---|
| Media Type | (kOe) | (kOe) | Footprint | (dB) | ADC |
| Five Layer | 4730 | 2161 | 3.48 | −5.59 | 418 |
| Seven Layer | 4761 | 2198 | 3.51 | −5.93 | 428 |

Various embodiments of the invention have been described. The implementations described above and other implementations are within the scope of the following claims.

1. An apparatus comprising:
a hard granular layer;
an exchange break layer formed on the hard granular layer, wherein the exchange break layer consists essentially of ruthenium; and
a soft granular layer formed on the exchange break layer.

2. The apparatus of claim 1, wherein the exchange break layer comprises a thickness of less than about 3 angstroms.

3. The apparatus of claim 1, wherein the exchange break layer comprises a thickness of about 2 angstroms.

4. The apparatus of claim 1, wherein a magnetic anisotropy of the soft granular layer is lower than a magnetic anisotropy of the hard granular layer.

5. The apparatus of claim 1, further comprising a continuous granular composite layer formed on the soft granular layer.

6. The apparatus of claim 5, wherein the exchange break layer comprises a first exchange break layer, further comprising a second exchange break layer formed on the soft granular layer, and wherein the continuous granular composite layer is formed on the second exchange break layer.

7. An apparatus comprising:
n magnetic layers; and
n−1 exchange break layers, wherein n is greater than or equal to three, and wherein the n−1 exchange break layers alternate with the n magnetic layers in the magnetic recording layer.

8. The apparatus of claim 7, wherein the n magnetic layers comprise a hard granular layer, a soft granular layer, and a continuous granular composite layer, wherein the n−1 exchange break layers comprise a first exchange break layer and a second exchange break layer, and wherein the first exchange break layer is formed on the hard granular layer, the soft granular layer is formed on the first exchange break layer, the second exchange break layer is formed on the soft granular layer, and the continuous granular composite layer is formed on the second exchange break layer.

9. The apparatus of claim 8, wherein a magnetic anisotropy of the soft granular layer is lower than a magnetic anisotropy of the hard granular layer, and wherein a magnetic anisotropy of the continuous granular composite layer is lower than the magnetic anisotropy of the soft granular layer.

10. The apparatus of claim 7, wherein the n magnetic layers comprise a hard granular layer, an intermediate granular layer, and a soft granular layer, wherein the n−1 exchange break layers comprise a first exchange break layer and a second exchange break layer, and wherein the first exchange break layer is formed on the hard granular layer, the intermediate granular layer is formed on the first exchange break layer, the second exchange break layer is formed on the intermediate granular layer, and the soft granular layer is formed on the second exchange break layer.

11. The apparatus of claim 10, wherein a magnetic anisotropy of the soft granular layer is lower than a magnetic anisotropy of the intermediate granular layer, and wherein a magnetic anisotropy of the intermediate granular layer is lower than the magnetic anisotropy of the hard granular layer.

12. The apparatus of claim 10, further comprising a continuous granular composite layer formed on the soft granular layer.

13. The apparatus of claim 7, further comprising a continuous granular composite layer formed on the n^{th} magnetic layer.

14. The apparatus of claim 7, wherein a first of the n−1 exchange break layers consists essentially of ruthenium.

15. The apparatus of claim 7, wherein a first of the n−1 exchange break layers comprises a thickness of less than about 3 angstroms.

16. The apparatus of claim 15, wherein a first of the n−1 exchange break layers comprises a thickness of about 2 angstroms.

17. The apparatus of claim 7, wherein a second of the n−1 exchange break layers consists essentially of ruthenium.

18. The apparatus of claim 7, wherein a second exchange break layer of the n−1 exchange break layers comprises at least one of a CoCr alloy, a CoRu alloy, or a CoCrRu alloy.

19. A method of forming a perpendicular magnetic recording layer comprising:
forming a hard granular layer;
forming an exchange break layer on the hard granular layer, wherein the exchange break layer consists essentially of ruthenium; and
forming a soft granular layer on the exchange break layer.

20. The method of claim 19, wherein the exchange break layer comprises a first exchange break layer, and further comprising:
forming a second exchange break layer on the soft granular layer; and
forming a continuous granular composite layer on the second exchange break layer.
